(19) United States
(12) Patent Application Publication
(10) Pub. No.: US 2026/0241524 A1
(43) Pub. Date: Aug. 20, 2026

(54) DRIVING TOOL

(71) Applicant: Max Co., Ltd., Tokyo (JP)

(72) Inventors: Kousuke Moriwaki, Tokyo (JP); Keisuke Ida, Tokyo (JP)

(21) Appl. No.: 19/541,808

(22) Filed: Feb. 17, 2026

(30) Foreign Application Priority Data
Feb. 17, 2025 (JP) 2025-023812

(51) Int. Cl. B25C 1/00; B25C 1/04

(52) U.S. Cl. CPC B25C 1/008; B25C 1/042; B25C 1/047

(57) ABSTRACT

A driving tool includes a main body, a main chamber storing compressed air, a striking cylinder moving a striking piston in an axial direction, a main valve portion configured to control supply of the compressed air to the striking cylinder, a trigger valve portion actuating the main valve portion, a trigger portion actuating the trigger valve portion, and a contact portion movable in a driving direction of the striking piston. The contact portion includes a contact top to be pressed against a driven member and a contact arm. The trigger valve portion includes a pilot valve and a trigger valve stem. The trigger portion includes a trigger lever and a contact lever portion engageable with the contact arm and the trigger valve stem. A position limiting surface in the main body limits movement of the contact lever portion.

### CROSS-REFERENCE TO RELATED APPLICATIONS

The present application claims priority from Japanese Patent Application No. 2025-023812 filed on Feb. 17, 2025, the entire contents of which are incorporated herein by reference.

### TECHNICAL FIELD

The present disclosure relates to a driving tool for driving a consumable into a driven member.

### BACKGROUND ART

A driving tool that drives out a consumable such as a screw or a nail performs a driving operation by engagement between a contact portion that moves by being pressed against a driven member and a contact lever that moves in conjunction with a trigger lever.

In the related art, there has been a driving machine which can switch between single driving in which a trigger lever is required to be pulled each time, and continuous driving in which the driving operations are performed continuously while the trigger lever is pulled, by changing an operation order of the trigger lever and a contact portion.

A technique has been proposed in which, when the trigger lever is pulled in a state in which the contact portion is pressed against the driven member and moved, the contact lever is engaged with a trigger valve stem and maintained in a retreated state, and is not engaged with the contact portion, thereby restricting the continuous driving and performing the single driving (for example, see JP5286939B).

### SUMMARY

However, in the structure in which the contact lever is engaged with the trigger valve stem and maintained, since a contact surface between the contact lever and the trigger valve stem is small, in order to keep the contact arm in a state of being engaged with a tip end of a trigger valve, dimensional tolerances are stringent, and high machining accuracy is required. Further, in the case where the trigger valve stem is provided with a recessed portion for stable engagement, the strength may be insufficient. Further, when the contact lever is pushed by the trigger valve stem, if an uneven load in a lateral direction is applied to the trigger valve stem, not only will stress concentrate in the recessed portion, but the sealing performance of the trigger valve stem will also deteriorate.

The present invention has been made to solve such a problem, and an object thereof is to provide a driving tool that can switch between continuous driving and single driving by changing an operation order of a trigger lever and a contact portion, and that can reliably restrict continuous driving operations of consumables during the single driving.

A driving tool includes: a main body; a main chamber configured to store compressed air; a striking cylinder configured to move a striking piston in an axial direction by being supplied with the compressed air stored in the main chamber; a main valve portion configured to open and close communication between the striking cylinder and the main chamber; a trigger valve portion configured to cause the main valve portion to operate; a trigger portion configured to cause the trigger valve portion to operate; and a contact portion supported to be movable in a driving direction of the striking piston and configured to cause the trigger valve portion to operate in cooperation with an operation of the trigger portion. The main body includes a body portion extending in an up-down direction and a handle portion extending from the body portion in a direction intersecting the body portion. The contact portion includes a contact top configured to be pressed against a driven member and a contact arm connected to the contact top and having an arm tip end portion engageable with the trigger portion. The trigger valve portion includes a pilot valve causing the main valve portion to operate and a trigger valve stem controlling intake and exhaust of compressed air to switch presence and absence of operation of the pilot valve. The trigger portion includes: a trigger lever movably supported with respect to the main body; a contact lever portion movably supported by the trigger lever and engageable with the contact arm and the trigger valve stem of the trigger valve portion; and a resilient member configured to bias the contact lever portion to a position where the contact lever portion is engaged with the contact arm by protruding the contact lever portion to a movement path of the arm tip end portion of the contact arm. The main body includes a position limiting surface that is contactable by a restricted portion of the contact lever portion and limits movement of the contact lever portion to the position where the contact lever portion is engaged with the contact arm.

In the present disclosure, when the contact top is pressed against the driven member and the driving tool is moved in a direction approaching the driven member, the contact arm moves upward relative to the main body, and the contact arm and a contact lever portion are engaged with each other. Next, when the trigger lever is pulled, the trigger valve is operated by the cooperation of the contact lever portion and the trigger lever, and the main valve is operated by the operation of the trigger valve, and the consumable is driven out.

Further, when the trigger lever is pulled after the contact top is pressed against the driven member and the contact arm moves upward relative to the main body, a movement amount of the contact lever portion to the position where it is engaged with the contact arm is restricted by the restricting portion. When the driving tool is moved away from the driven member and the contact arm is moved downward relative to the main body, the contact lever portion deviates from the position where it is engaged with the contact arm. Therefore, since the movement amount of the contact lever portion to the position where the contact lever portion is engaged with the contact arm is restricted, the contact arm and the contact lever portion cannot be engaged with each other again even when the contact arm is moved upward after the contact arm deviates from the engagement position, and the trigger valve does not operate even when the driving tool moves in a direction approaching the driven member next time.

In the present disclosure, after the contact top is pressed against the driven member and the driving tool is moved in a direction approaching the driven member, when the trigger lever is pulled, the consumable is driven out. However, after the driving, even when the driving tool is moved in the direction away from and the direction approaching the driven member while the trigger is pulled, since the movement of the contact lever portion to the position where the contact lever portion is engaged with the contact arm is restricted by the restricting portion, the trigger valve does not operate and the consumable is not driven out.

Accordingly, it is possible to restrict the continuous driving operations of the consumables. Further, since the restricting portion that restricts the movement of the contact lever portion to the position where the contact lever portion engages with the contact arm is provided in the main body, the contact surface between the contact lever portion and the restricting portion is sufficiently secured, precise machining of the trigger valve stem, which is a small component, and a highly accurate shape are unnecessary, high accuracy is not required for the dimensional setting, and high machining accuracy is not required. Therefore, it can be applied at low cost. Further, strength can be ensured. Therefore, the position of the contact lever portion can be reliably restricted.

### BRIEF DESCRIPTION OF DRAWINGS

Illustrative embodiments of the present disclosure will be described in detail based on the following figures, wherein:

FIG. 1 is a side sectional view illustrating an example of a nail gun according to the present illustrative embodiment;

FIG. 2 is an external side view illustrating the example of the nail gun according to the present illustrative embodiment;

FIG. 3 is a side sectional view of a main part illustrating the example of the nail gun according to the present illustrative embodiment;

FIG. 4 is a perspective view of a main part illustrating the example of the nail gun according to the present illustrative embodiment;

FIG. 5 is a side sectional view of a main part of a trigger portion illustrating the example of the nail gun according to the present illustrative embodiment;

FIG. 6 is a side sectional view of the main part of the trigger portion illustrating an example of operation of the nail gun according to the present illustrative embodiment during continuous driving;

FIG. 7 is a side sectional view of the main part of the trigger portion illustrating the example of the operation of the nail gun according to the present illustrative embodiment during the continuous driving;

FIG. 8 is a side sectional view of the main part of the trigger portion illustrating the example of the operation of the nail gun according to the present illustrative embodiment during the continuous driving;

FIG. 9 is a side sectional view of a main part illustrating an example of operation of a trigger valve portion;

FIG. 10 is a side sectional view of the main part of the trigger portion illustrating an example of operation of the nail gun according to the present illustrative embodiment during single driving;

FIG. 11 is a side sectional view of the main part of the trigger portion illustrating the example of the operation of the nail gun according to the present illustrative embodiment during the single driving;

FIG. 12 is a side sectional view of the main part of the trigger portion illustrating the example of the operation of the nail gun according to the present illustrative embodiment during the single driving;

FIG. 13 is a side sectional view of the main part of the trigger portion illustrating the example of the operation of the nail gun according to the present illustrative embodiment during the single driving;

FIG. 14 is a side sectional view of the main part of the trigger portion illustrating the example of the operation of the nail gun according to the present illustrative embodiment during the single driving;

FIG. 15 is a side sectional view of the main part of the trigger portion illustrating the example of the operation of the nail gun according to the present illustrative embodiment during the single driving;

FIG. 16 is a side sectional view of the main part of the trigger portion illustrating the example of the operation of the nail gun according to the present illustrative embodiment during the single driving;

FIG. 17 is a side sectional view of a main part of a trigger portion illustrating a modification of the nail gun according to the present illustrative embodiment;

FIG. 18 is a side sectional view of the main part of the trigger portion illustrating the modification of the nail gun according to the present illustrative embodiment;

FIG. 19 is a side sectional view of a main part of a trigger portion illustrating an example of operation of restricting continuous driving of the nail gun according to a modification;

FIG. 20 is a side sectional view of the main part of the trigger portion illustrating the example of the operation of restricting the continuous driving of the nail gun according to the modification; and

FIG. 21 is a side sectional view of the main part of the trigger portion illustrating the example of the operation of restricting the continuous driving of the nail gun according to the modification.

### DESCRIPTION OF EMBODIMENTS

Hereinafter, an illustrative embodiment of a nail gun as an example of a driving tool of the present invention will be described with reference to the drawings.

### Configuration Example of Nail Gun

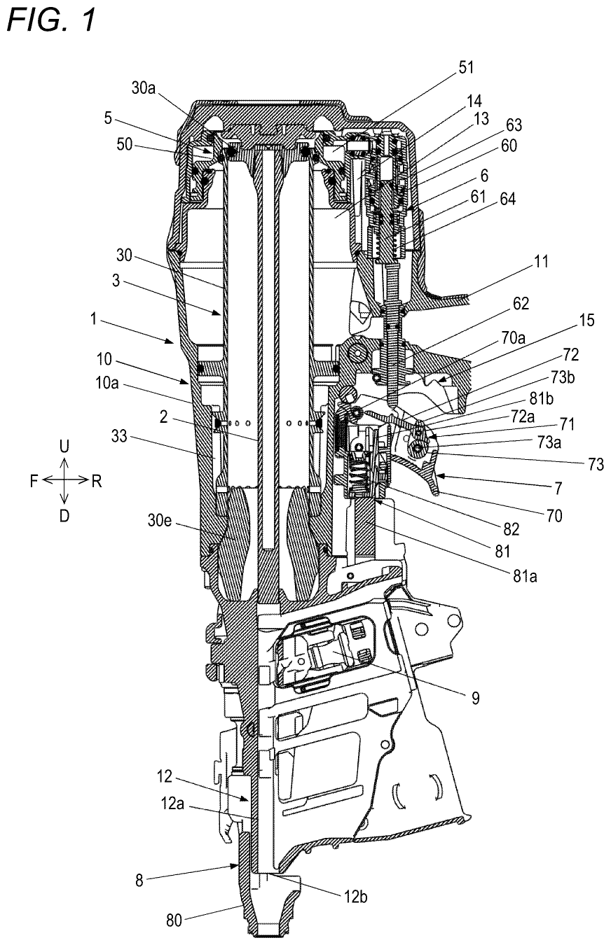

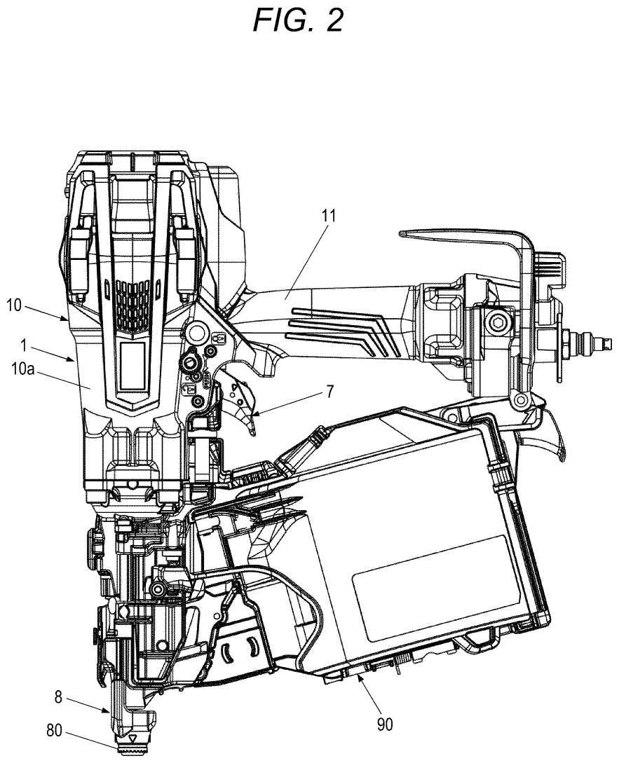

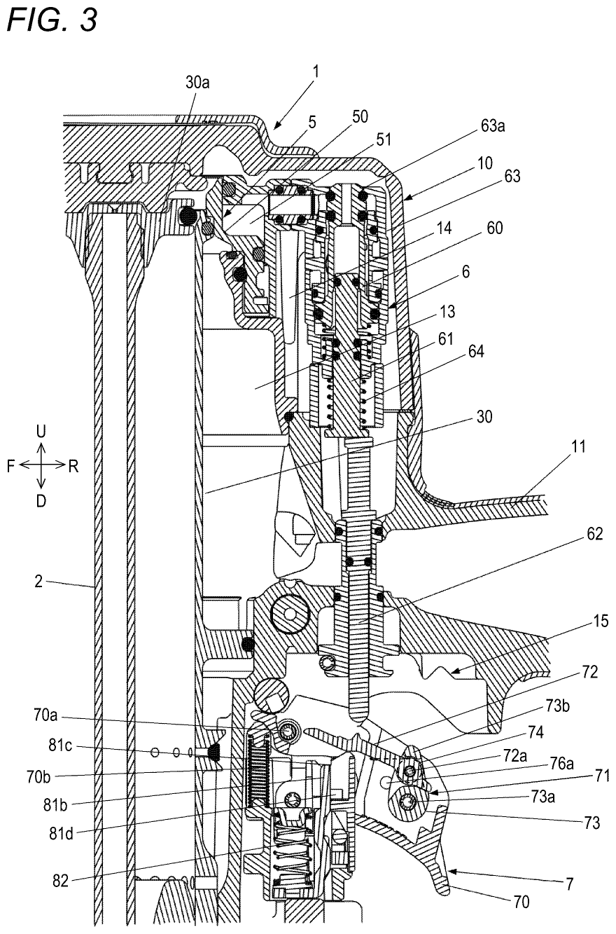

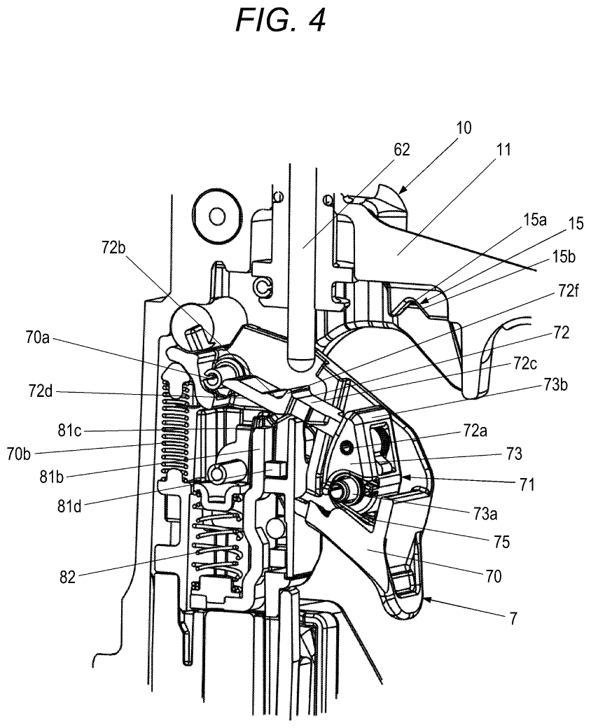

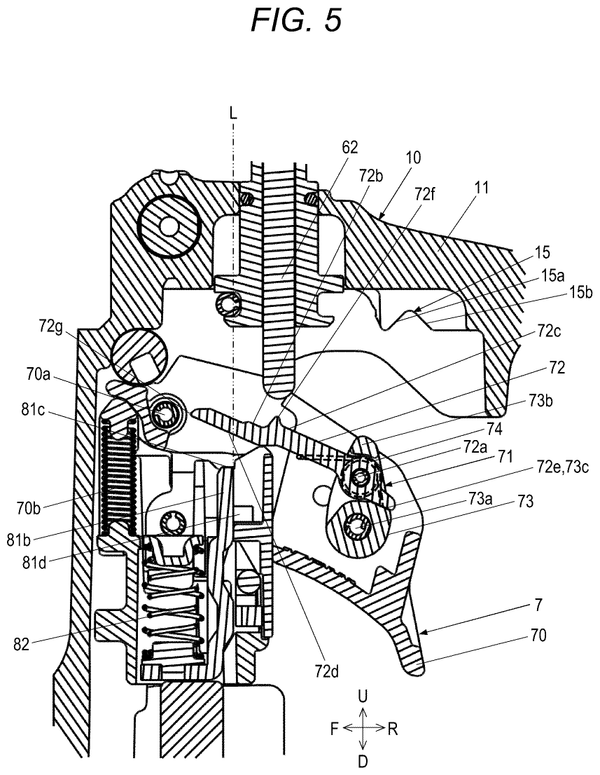

FIG. 1 is a side sectional view illustrating an example of a nail gun according to the present illustrative embodiment, FIG. 2 is an external side view illustrating the example of the nail gun according to the present illustrative embodiment, FIG. 3 is a side sectional view of a main part illustrating the example of the nail gun according to the present illustrative embodiment, FIG. 4 is a perspective view of a main part illustrating the example of the nail gun according to the present illustrative embodiment, and FIG. 5 is a side sectional view of a main part of a trigger portion illustrating the example of the nail gun according to the present illustrative embodiment.

A nail gun 1 causes a driver 2 to move in an axial direction using air pressure of compressed air. The nail gun 1 drives a nail (not illustrated), which is a consumable, into a driven member by moving the driver 2 in the axial direction.

The nail gun 1 includes a main body 10. The nail gun 1 has such a form that a person holds it with his or her hand to use it, and includes a body portion 10a to which some of various mechanical components to be described later are attached, and a handle portion 11 to which some of the various mechanical components are attached and that is gripped by a hand. The body portion 10a extends in an up-down direction along the axial direction of the driver 2.

In the main body 10, a handle portion 11 is provided near the middle along an extension direction of the body portion 10a. The handle portion 11 extends from the body portion 10a in a direction intersecting the body portion 10a extending in the up-down direction. The exterior of the main body 10 is made of a resin, and the body portion 10a and the handle portion 11 are integrally formed. The nail gun 1 also includes a nose portion 12. The nose portion 12 is attached to one side of the main body 10 along the extension direction of the body portion 10a.

As illustrated in FIG. 1 and the like, the nail gun 1 is illustrated with the nose portion 12 facing downward, one side along the extension direction of the body portion 10a, which is a driving direction of the nail (not illustrated), is referred to as a lower side, and the other side along the extension direction of the body portion 10a is referred to as an upper side. In the nail gun 1, a down direction is indicated by an arrow D. In the nail gun 1, an up direction opposite to the down direction is indicated by an arrow U. The driver 2 has the axial direction oriented along the up-down direction, and moves downward and upward. In the nail gun 1, a direction in which the body portion 10a is provided along a direction in which the handle portion 11 extends and that intersects the up-down direction is referred to as a front side, and a side opposite to the body portion 10a is referred to as a rear side. In the nail gun 1, a front direction is indicated by an arrow F, and a rear direction is indicated by an arrow R. When FIG. 1 and the like are viewed with the direction in which the body portion 10a extends as the up-down direction, a left side is the front direction, and a right side is the rear direction.

The nose portion 12 includes an injection passage 12a through which a nail is supplied, and an injection port 12b through which the nail supplied to the injection passage 12a is injected.

The injection passage 12a extends along the up-down direction in which the driver 2 moves. The injection port 12b is formed by providing an opening on a lower end along an extension direction of the injection passage 12a.

The nail gun 1 includes a driving portion 3 that drives the nail into the driven member. The driving portion 3 includes a striking cylinder 30 that causes the driver 2 to move in the axial direction, and a striking piston 30a that moves by the air pressure of the compressed air supplied to the striking cylinder 30.

The striking cylinder 30 is provided inside the body portion 10a and formed by a cylindrical space extending in the up-down direction.

The striking cylinder 30 is internally provided with the striking piston 30a. The striking piston 30a has a circular plate shape, a cylindrical shape, and the like that can move inside the striking cylinder 30 along the up-down direction. The striking piston 30a is attached in such a shape that the driver 2 protrudes downward.

In the nail gun 1, when the striking piston 30a moves in the up-down direction inside the striking cylinder 30, the driver 2 moves in the arrow D direction and the arrow U direction along the axial direction.

Accordingly, in the nail gun 1, the striking piston 30a moves the driver 2 downward as indicated by the arrow D along the axial direction by the air pressure of the compressed air supplied to the striking cylinder 30, and the nail is driven into the driven member.

The striking cylinder 30 includes a bumper 30e at a lower end in the axial direction. The bumper 30e is made of an annular elastic body and has a shape that allows the striking piston 30a to come into contact with it. The striking piston 30a is movable downward to a position in contact with the bumper 30e. In the striking piston 30a and the driver 2, a position where the striking piston 30a comes into contact with the bumper 30e is a bottom dead center position. The bumper 30e is elastically deformable, and the bottom dead center position of the striking piston 30a and the driver 2 moves within a range in which the bumper 30e is elastically deformable.

The nail gun 1 includes a main valve portion 5 that switches between supplying and not supplying the compressed air to the striking cylinder 30, a trigger valve portion 6 that causes the main valve portion 5 to operate, and a trigger portion 7 that causes the trigger valve portion 6 to operate. The nail gun 1 also includes a contact portion 8 that causes the trigger valve portion 6 to be operable in cooperation with the operation of the trigger portion 7. Further, the nail gun 1 includes a feeding portion 9 that feeds the nail (not illustrated), which is a consumable, to the nose portion 12, and a magazine 90 that accommodates the nail fed by the feeding portion 9.

The nail gun 1 includes a main chamber 13 to which the compressed air is supplied from an external air compressor (not illustrated). The main chamber 13 is provided on an outer periphery of the striking cylinder 30 in the handle portion 11 and in the body portion 10a connected to the handle portion 11. The nail gun 1 further includes an exhaust chamber 14 that exhausts the compressed air.

The nail gun 1 also includes a blowback chamber 33 that returns the striking piston 30a that has moved to the bottom dead center position to a top dead center position.

The main valve portion 5 includes a head valve 50 that opens and closes communication between the main chamber 13 and the striking cylinder 30, and a control chamber 51 that controls opening and closing of the head valve 50 by exhaust of the compressed air.

The main valve portion 5 is provided with the head valve 50 around the striking cylinder 30 on an upper portion in the body portion 10a. The head valve 50 is supported to be movable in the up-down direction. The main valve portion 5 is provided with the control chamber 51 around the head valve 50 on the upper portion in the body portion 10a.

The trigger valve portion 6 includes a pilot valve 60 that opens and closes the control chamber 51, a trigger valve upper stem 61 that causes the pilot valve 60 to operate, and a trigger valve housing 63 into which the pilot valve 60 and the trigger valve upper stem 61 are inserted so as to be movable in the up-down direction. The nail gun 1 also includes a trigger valve lower stem 62 that causes the trigger valve upper stem 61 to operate. The trigger valve portion 6 further includes a trigger valve biasing member 64 that biases the trigger valve upper stem 61 and the trigger valve lower stem 62 via the trigger valve upper stem 61.

In the trigger valve portion 6, the pilot valve 60, the trigger valve upper stem 61, and the trigger valve biasing member 64 are assembled to the trigger valve housing 63, and are provided on an upper side of the handle portion 11 and on an upper side of the body portion 10a. The trigger valve lower stem 62 is provided between the trigger portion 7 and the trigger valve upper stem 61. In the present illustrative embodiment, the trigger valve lower stem 62 is disposed between the body portion 10a and the handle portion 11. The pilot valve 60 and the trigger valve upper stem 61 are supported by the trigger valve housing 63 so as to be movable in the up-down direction. The trigger valve lower stem 62 is supported to be movable in the up-down direction in the vicinity of a portion where the handle portion 11 is connected to the body portion 10a. Further, the trigger valve upper stem 61 and the trigger valve lower stem 62 are biased downward by the trigger valve biasing member 64.

The trigger valve housing 63 includes an exhaust portion 63a that is opened and closed by the movement of the pilot valve 60 in the up-down direction.

The nail gun 1 includes a connection flow path 67 that connects the trigger valve housing 63 to the control chamber 51 of the main valve portion 5. The connection flow path 67 extends in a lateral direction from an upper end side of the trigger valve housing 63 in the vicinity of the exhaust portion 63a and connects a space on the upper end side in the trigger valve housing 63 to the control chamber 51.

A sign ON position is a position where the trigger valve portion 6 is operable. That is, in the trigger valve portion 6, in a state in which the trigger valve upper stem 61 moves downward to a predetermined position, the compressed air is supplied from the main chamber 13 to a lower side of the pilot valve 60, and the pilot valve 60 moves upward. When the pilot valve 60 moves upward, the pilot valve 60 closes the exhaust portion 63a. In the trigger valve portion 6, when the trigger valve lower stem 62 is pushed upward by an operation of the trigger portion 7 to be described later, the trigger valve upper stem 61 is pushed by the trigger valve lower stem 62 and moves upward. When the trigger valve upper stem 61 moves upward by a predetermined amount, a flow path through which the compressed air is exhausted from a trigger valve lower chamber formed on the lower side of the pilot valve 60 to the exhaust chamber 14 is formed, and the pilot valve 60 moves downward by exhausting the compressed air from the trigger valve lower chamber. When the pilot valve 60 moves downward, the exhaust portion 63a opens. Accordingly, the compressed air passes through the connection flow path 67 from the control chamber 51 and is exhausted to the exhaust chamber 14. As described above, the position of the trigger valve upper stem 61 at which the trigger valve upper stem 61 moves upward by a predetermined amount and the pilot valve 60 moves downward is the sign ON position where the trigger valve portion 6 is operable.

The contact portion 8 includes a contact top 80 protruding downward from the injection port 12b, a first contact arm 81a connected to the contact top 80, and a second contact arm 81b engageable with a contact lever portion 71 (to be described later) of the trigger portion 7. The first contact arm 81a is an example of a contact arm, and is supported by the nose portion 12 so as to be relatively movable in the up-down direction. The second contact arm 81b is an example of the contact arm, and is supported to be movable in the up-down direction relative to the body portion 10a. The second contact arm 81b includes, on an upper end in the up-down direction, an arm tip end portion 81c engageable with the contact lever portion 71 to be described later. In the contact portion 8, the second contact arm 81b is biased by the biasing member 82 in the down direction, which is a direction in which the contact top 80 protrudes downward from the injection port 12b. Accordingly, in the contact portion 8, the contact top 80 is pressed against the driven member, so that the first contact arm 81a pushes up the second contact arm 81b, and the second contact arm 81b moves upward relative to the body portion 10a. The first contact arm 81a and the second contact arm 81b may be integrally formed. Hereinafter, the first contact arm 81a and the second contact arm 81b may be collectively referred to as a contact arm 81.

The trigger portion 7 includes a trigger lever 70. The trigger lever 70 extends from the body portion 10a along the handle portion 11, and an end portion thereof on a body portion 10a side is supported to be rotatable with respect to the body portion 10a about a shaft portion 70a as a fulcrum. The trigger portion 7 includes a trigger biasing member 70b that biases the trigger lever 70. The trigger biasing member 70b is formed of, for example, a coil spring, and an end portion of the trigger lever 70 on a side extending from the shaft portion 70a along the handle portion 11 is biased in a direction away from the handle portion 11.

The trigger portion 7 includes the contact lever portion 71. The contact lever portion 71 includes a first lever 72 engageable with the contact arm 81 and the trigger valve lower stem 62 of the trigger valve portion 6, and a second lever 73 supporting the first lever 72 to be rotatable with respect to the trigger lever 70.

The first lever 72 extends in a direction along the trigger lever 70, and a portion on a rear side, which is a direction away from the shaft portion 70a along an extension direction of the handle portion 11, is connected to the second lever 73 by a first shaft portion 72a. The first lever 72 is supported to be rotatable about the first shaft portion 72a with respect to the second lever 73.

The second lever 73 is supported by the second shaft portion 73a to be rotatable with respect to the trigger lever 70. The second lever 73 extends from the second shaft portion 73a in a direction intersecting the first lever 72, and supports the first lever 72 via the first shaft portion 72a.

Accordingly, the first lever 72 and the second lever 73 of the contact lever portion 71 rotate with respect to the trigger lever 70 about the second shaft portion 73a as a fulcrum. Further, the first lever 72 of the contact lever portion 71 rotates with respect to the second lever 73 via the first shaft portion 72a, with the first shaft portion 72a as a fulcrum.

The first lever 72 includes a single-driving trigger valve stem contact portion 72b, a continuous-driving trigger valve stem contact portion 72c, and a contact arm contact portion 72d.

The single-driving trigger valve stem contact portion 72b is provided on an upper surface side of the first lever 72, which is a side facing the trigger valve lower stem 62, and on a side close to the lever tip end portion 72g opposite to the first shaft portion 72a.

The continuous-driving trigger valve stem contact portion 72c is provided between the single-driving trigger valve stem contact portion 72b and the first shaft portion 72a on the upper surface side of the first lever 72 facing the trigger valve lower stem 62.

The contact arm contact portion 72d is provided on a lower surface side of the first lever 72 facing the contact arm 81 and on the side close to the lever tip end portion 72g.

The first lever 72 includes a contact portion 72e. The contact portion 72e is provided on a side opposite to the side where the single-driving trigger valve stem contact portion 72b, the continuous-driving trigger valve stem contact portion 72c, and the contact arm contact portion 72d are provided with the first shaft portion 72a interposed therebetween, and on the lower surface side, which is a side where the contact arm contact portion 72d is provided.

The first lever 72 includes a lever restricting portion 72f. The lever restricting portion 72f is provided between the single-driving trigger valve stem contact portion 72b and the continuous-driving trigger valve stem contact portion 72c on the upper surface side of the first lever 72 facing the trigger valve lower stem 62. The lever restricting portion 72f is implemented by a convex portion protruding upward at a predetermined height at which the trigger valve lower stem 62 can come into contact with upper surfaces of the single-driving trigger valve stem contact portion 72b and the continuous-driving trigger valve stem contact portion 72c.

The second lever 73 includes a restricted portion 73b. The restricted portion 73b is provided at a position extending from the second shaft portion 73a toward the first shaft portion 72a on a first shaft portion 72a side, which is a direction away from the second shaft portion 73a, with respect to the second shaft portion 73a. The restricted portion 73b is a portion that comes into contact with a restricting portion 15 to be described later to restrict the rotation of the second lever 73. In the present illustrative embodiment, the restricted portion 73b is implemented by providing a convex portion at an end portion of the second lever 73 on a side where the first shaft portion 72a is provided. However, the restricted portion 73b may be configured between the first shaft portion 72a and the second shaft portion 73a as long as it can come into contact with the restricting portion 15 and restrict the rotation. The second lever 73 includes a contacted portion 73c. The contacted portion 73c is implemented by providing a surface facing the contact portion 72e of the first lever 72 between the second shaft portion 73a and the restricted portion 73b.

The contact lever portion 71 includes a first lever biasing member 74 that biases the first lever 72 with respect to the second lever 73. The first lever biasing member 74 is an example of a resilient member, is implemented by, for example, a torsion coil spring, a leaf spring, or an elastic body such as rubber, and biases the first lever 72 to a position where the contact portion 72e and the contacted portion 73c are in contact with each other. That is, the first lever biasing member 74 biases the first lever 72 in a direction in which a distance between the contact arm contact portion 72d and the second shaft portion 73a increases by rotating the first lever 72 with respect to the second lever 73 about the first shaft portion 72a as a fulcrum. Accordingly, the first lever 72 of the contact lever portion 71 is biased to a position where the first lever 72 can be engaged with the contact arm 81.

The trigger lever 70 includes a second lever biasing member 75 that biases the contact lever portion 71. The second lever biasing member 75 is an example of a biasing portion and is implemented by, for example, a torsion coil spring, and the second lever 73 is rotated about the second shaft portion 73a as the fulcrum to bias the second lever 73 in a down direction in which the first lever 72 is away from the trigger valve lower stem 62.

The main body 10 includes, in the handle portion 11, the restricting portion 15 that restricts the position of the contact lever portion 71 with respect to the trigger lever 70. When the trigger lever 70 rotates about the shaft portion 70a as a fulcrum in a direction approaching the handle portion 11, a movement trajectory of the restricted portion 73b of the second lever 73 changes depending on whether the second lever 73 rotates about the second shaft portion 73a as the fulcrum and a rotation angle. In a state in which the movement trajectory of the restricted portion 73b passes through a portion where the restricting portion 15 is provided, when the trigger lever 70 rotates in a direction approaching the handle portion 11 about the shaft portion 70a as a fulcrum, a portion of the restricting portion 15 with which the restricted portion 73b can come into contact is integrally formed with the handle portion 11. The restricting surfaces formed in the restricting portion 15 (first restricting surface 15a and second restricting surface 15b described below) function as a position limiting surface which is contactable by the restricted portion 73b of the contact lever portion 71 and limits movement of the contact lever portion 71 to a position where the contact lever portion 71 is engaged with the contact arm.

The restricting portion 15 includes a first restricting surface 15a. The first restricting surface 15a is formed as a surface with which a front surface of the restricted portion 73b can come into contact when the trigger lever 70 rotates about the shaft portion 70a as a fulcrum in a direction approaching the handle portion 11 in a state in which the movement trajectory of the restricted portion 73b passes through the portion where the restricting portion 15 is provided. When the front surface of the restricted portion 73b comes into contact with the first restricting surface 15a of the restricting portion 15, the second lever 73 is restricted from rotating forward around the second shaft portion 73a as the fulcrum. Accordingly, the first lever 72 is restricted from moving in a direction in which the distance between the contact arm contact portion 72d and the second shaft portion 73a increases. Thus, the first restricting surface 15a is one example of the position limiting surface which is contactable by the restricted portion 73b of the contact lever portion 71 and limits movement of the contact lever portion 71 to a position where the contact lever portion 71 is engaged with the contact arm.

The restricting portion 15 may include a second restricting surface 15b at a position facing the first restricting surface 15a, and may be implemented by a recessed portion. The second restricting surface 15b is formed as a surface with which a rear surface of the restricted portion 73b can come into contact when the trigger lever 70 rotates about the shaft portion 70a as the fulcrum in the direction approaching the handle portion 11 in the state in which the movement trajectory of the restricted portion 73b passes through the portion where the restricting portion 15 is provided. When the rear surface of the restricted portion 73b comes into contact with the second restricting surface 15b of the restricting portion 15, the second lever 73 is restricted from rotating rearward unnecessarily by a force applied from the trigger valve lower stem 62 to the first lever 72 by a movement operation of the trigger valve lower stem 62 in the down direction. Thus, the second restricting surface 15b is also one example of the position limiting surface which is contactable by the restricted portion 73b of the contact lever portion 71 and limits a position of the contact lever portion 71.

The contact portion 8 is biased downward by the biasing member 82, and a standby position is a position where a predetermined portion such as the first contact arm 81a or the second contact arm 81b comes into contact with a stopper (not illustrated) provided in the body portion 10a, the nose portion 12, or the like and cannot move further downward. Further, in the trigger portion 7, a portion of the trigger lever 70 opposite to the shaft portion 70a is biased by the trigger biasing member 70b in a direction away from the handle portion 11, and a standby position is a position where a predetermined portion such as the trigger lever 70 comes into contact with the stopper (not illustrated) provided in the body portion 10a, the handle portion 11, or the like and cannot rotate any more.

In the contact lever portion 71, when the trigger lever 70 and the contact portion 8 are at the standby positions, when the trigger lever 70 is pulled, the first lever 72 can move to a position where it is engaged with the second contact arm 81b.

In the contact lever portion 71, when the restricted portion 73b is not engaged with the restricting portion 15 in a state in which the trigger lever 70 is pulled from the standby position, the first lever 72 and the second lever 73 are rotatable with respect to the trigger lever 70 about the second shaft portion 73a as a fulcrum. That is, in the contact lever portion 71, in a state in which the contact portion 72e of the first lever 72 and the contacted portion 73c of the second lever 73 are brought into contact with each other by the biasing of the first lever biasing member 74, and the first lever 72 and the second lever 73 are opened to the maximum, the first lever 72 and the second lever 73 are rotatable about the second shaft portion 73a as a fulcrum.

On the other hand, in the contact lever portion 71, when the restricted portion 73b is in a state of being engaged with the restricting portion 15 in a state in which the trigger lever 70 is pulled from the standby position, the first lever 72 is rotatable with respect to the trigger lever 70 about the first shaft portion 72a as a fulcrum. Since the restricted portion 73b is engaged with the restricting portion 15, the second lever 73 cannot rotate about the second shaft portion 73a as a fulcrum.

Further, in the contact lever portion 71, the first shaft portion 72a when the trigger lever 70 is pulled from the standby position and the restricted portion 73b is engaged with the restricting portion 15 has a longer distance from the shaft portion 70a than the first shaft portion 72a when the restricted portion 73b is not engaged with the restricting portion 15.

That is, in the contact lever portion 71, a horizontal distance from the first shaft portion 72a when the trigger lever 70 is pulled from the standby position and the restricted portion 73b is engaged with the restricting portion 15 to a movement trajectory of the arm tip end portion 81c of the second contact arm 81b moving in the up-down direction is longer than a horizontal distance from the first shaft portion 72a when the restricted portion 73b is not engaged with the restricting portion 15 to the movement trajectory of the arm tip end portion 81c.

Further, a distance from the lever tip end portion 72g of the first lever 72 to the first shaft portion 72a is shorter than a distance from the lever tip end portion 72g to the second shaft portion 73a in the state in which the first lever 72 and the second lever 73 are opened to the maximum.

When the restricted portion 73b is not engaged with the restricting portion 15 in a state in which the trigger lever 70 is pulled, the first lever 72 and the second lever 73 of the contact lever portion 71 integrally rotate about the second shaft portion 73a as a fulcrum in a state in which the first lever 72 and the second lever 73 are opened to the maximum, so that a movement trajectory of the lever tip end portion 72g draws a circle about the second shaft portion 73a. A movement trajectory L of the arm tip end portion 81c passes through the movement trajectory of the lever tip end portion 72g. Therefore, the first lever 72 of the contact lever portion 71 can move to a position where the first lever 72 is engaged with the arm tip end portion 81c of the second contact arm 81b.

On the other hand, in a state in which the trigger lever 70 is pulled, when the second lever 73 rotates about the second shaft portion 73a as a fulcrum and the restricted portion 73b is engaged with the restricting portion 15, the first lever 72 of the contact lever portion 71 rotates about the first shaft portion 72a as a fulcrum, so that the movement trajectory of the lever tip end portion 72g draws a circle about the first shaft portion 72a. In the movement trajectory of the lever tip end portion 72g, a range through which the movement trajectory of the arm tip end portion 81c passes and a range through which the movement trajectory of the arm tip end portion 81c does not pass are formed according to the position of the second contact arm 81b in the up-down direction and the position of the lever tip end portion 72g of the first lever 72 rotating about the first shaft portion 72a as a fulcrum. Therefore, the first lever 72 is restricted from moving to a position where the first lever 72 is engaged with the arm tip end portion 81c of the second contact arm 81b.

Accordingly, the restricting portion 15 restricts the movement of the contact lever portion 71 to the position where the contact lever portion 71 is engaged with the contact arm 81.

The contact arm 81 includes a second restricting portion 81d, which is provided on the second contact arm 81b. The second restricting portion 81d is provided in a range below the arm tip end portion 81c on a movement path of the lever tip end portion 72g of the first lever 72 in a state in which the first lever 72 is restricted, by the restricting portion 15, from moving to the position where the first lever 72 is engaged with the arm tip end portion 81c of the second contact arm 81b. Accordingly, in a state in which the second contact arm 81b has moved to a top dead center position, the first lever 72 of the contact lever portion 71 is pushed by the trigger valve lower stem 62, so that the second restricting portion 81d restricts the lever tip end portion 72g from moving further downward along a side surface of the second contact arm 81b. In a case where the second restricting portion 81d is not provided, when the lever tip end portion 72g moves downward along the side surface of the second contact arm 81b and an angle formed by the side surface of the second contact arm 81b and the first lever 72 becomes a predetermined acute angle, the first lever 72 may not return to the movement path of the arm tip end portion 81c. Thus, the second restricting portion 81d is one example of a second position limiting surface that restricts movement of the first lever 72 of the contact lever portion 71.

### Operation Example of Nail Gun

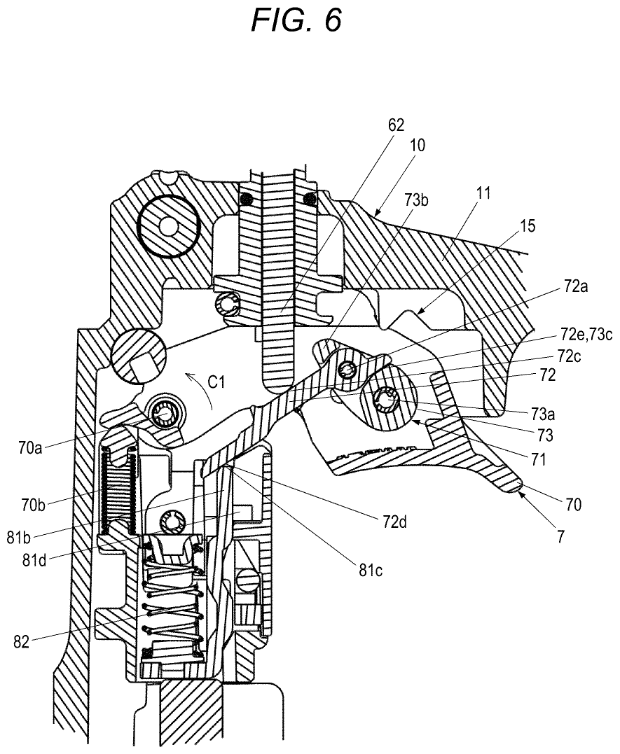

FIGS. 6 to 8 are side sectional views of the main part of the trigger portion illustrating an example of operation of the nail gun according to the present illustrative embodiment during continuous driving. Next, the operation of the nail gun 1 during the continuous driving will be described.

At the time of the continuous driving in which nails are driven continuously, an operator first pulls the trigger lever 70 from the standby state illustrated in FIG. 5. The operator does not press the contact top 80 against the driven member before pulling the trigger lever 70 during the continuous driving.

When the trigger lever 70 is pulled, as illustrated in FIG. 6, the trigger lever 70 rotates in an arrow C1 direction about the shaft portion 70a as a fulcrum while compressing the trigger biasing member 70b. When the trigger lever 70 rotates about the shaft portion 70a as a fulcrum, an end portion of the trigger lever 70 on the side extending from the shaft portion 70a along the handle portion 11 moves in a direction approaching the handle portion 11.

Further, when the trigger lever 70 rotates about the shaft portion 70a as a fulcrum, the contact lever portion 71 supported by the trigger lever 70 via the second shaft portion 73a also moves in synchronization. In the contact lever portion 71, the first lever 72 and the second lever 73 move in synchronization with the trigger lever 70 in a state in which the contact portion 72e of the first lever 72 and the contacted portion 73c of the second lever 73 are brought into contact with each other by the biasing of the first lever biasing member 74 and the first lever 72 and the second lever 73 are opened to the maximum. Note that the first lever 72 and the second lever 73 may not be opened to the maximum as long as a length from the lever tip end portion 72g of the first lever 72 to the second shaft portion 73a is shorter than a length from the movement trajectory of the arm tip end portion 81c to the second shaft portion 73a.

However, even when the trigger lever 70 rotates about the shaft portion 70a as a fulcrum and moves to a pulling completion position close to the specified position with respect to the handle portion 11, the first lever 72 moves the trigger valve upper stem 61 upward via the trigger valve lower stem 62 and does not move the trigger valve upper stem 61 to an operation position. Therefore, the trigger valve portion 6 does not move to the sign ON position where the trigger valve portion 6 is operable.

Further, even when the trigger lever 70 is moved to the pulling completion position, the restricted portion 73b of the second lever 73 is not engaged with the restricting portion 15. Accordingly, when the trigger lever 70 is moved to the pulling completion position, the first lever 72 is in a state in which the first lever 72 has moved to the position where the first lever 72 can be engaged with the contact arm 81.

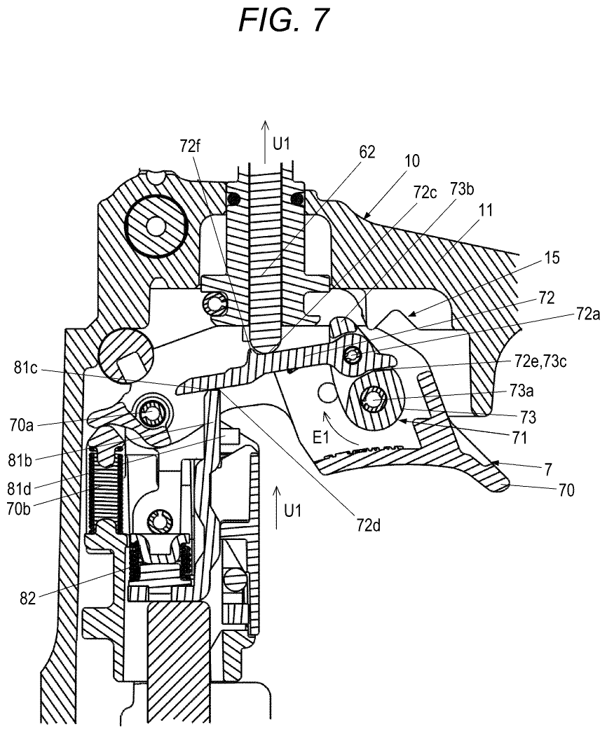

In a state in which the trigger lever 70 is pulled first, the operator presses the contact top 80 against the driven member, and moves the nail gun 1 in a direction approaching the driven member. When the contact top 80 is pressed against the driven member, as illustrated in FIG. 7, the first contact arm 81a pushes up the second contact arm 81b, and the second contact arm 81b moves upward as indicated by an arrow U1 relative to the main body 10 while compressing the biasing member 82.

When the second contact arm 81b moves upward relative to the main body 10, the arm tip end portion 81c comes into contact with the contact arm contact portion 72d, and pushes the first lever 72 of the contact lever portion 71 upward toward where the trigger valve lower stem 62 is disposed. When the first lever 72 is pushed upward in a state in which the restricted portion 73b of the second lever 73 is not engaged with the restricting portion 15, the contact lever portion 71 rotates in an arrow E1 direction with respect to the trigger lever 70 about the second shaft portion 73a as a fulcrum in the state in which the first lever 72 and the second lever 73 are opened to the maximum.

Accordingly, the first lever 72 of the contact lever portion 71 moves in a direction of pushing the trigger valve lower stem 62, so that the continuous-driving trigger valve stem contact portion 72c comes into contact with the trigger valve lower stem 62, and the trigger valve lower stem 62 is moved upward as indicated by the arrow U1 relative to the main body 10. In the contact lever portion 71, the first lever 72 and the second lever 73 are rotatable about the first shaft portion 72a and the second shaft portion 73a as fulcrums, respectively. On the other hand, when the first lever 72 moves rearward and the lever restricting portion 72f comes into contact with the trigger valve lower stem 62 in a state in which the continuous-driving trigger valve stem contact portion 72c is in contact with the trigger valve lower stem 62, the first lever 72 is restricted from moving rearward. Accordingly, the first lever 72 is maintained in a state in which the continuous-driving trigger valve stem contact portion 72c is in contact with the trigger valve lower stem 62. Further, the contact portion 72e of the first lever 72 and the contacted portion 73c of the second lever 73 are kept in contact with each other by the biasing of the first lever biasing member 74. Therefore, the first lever 72 and the second lever 73 rotate about the second shaft portion 73a as a fulcrum in the state in which the first lever 72 and the second lever 73 are opened to the maximum.

In the trigger valve portion 6, when the trigger valve lower stem 62 moves upward relative to the main body 10, the trigger valve upper stem 61 illustrated in FIGS. 1 and 3 is pushed by the trigger valve lower stem 62 and moves upward relative to the main body 10.

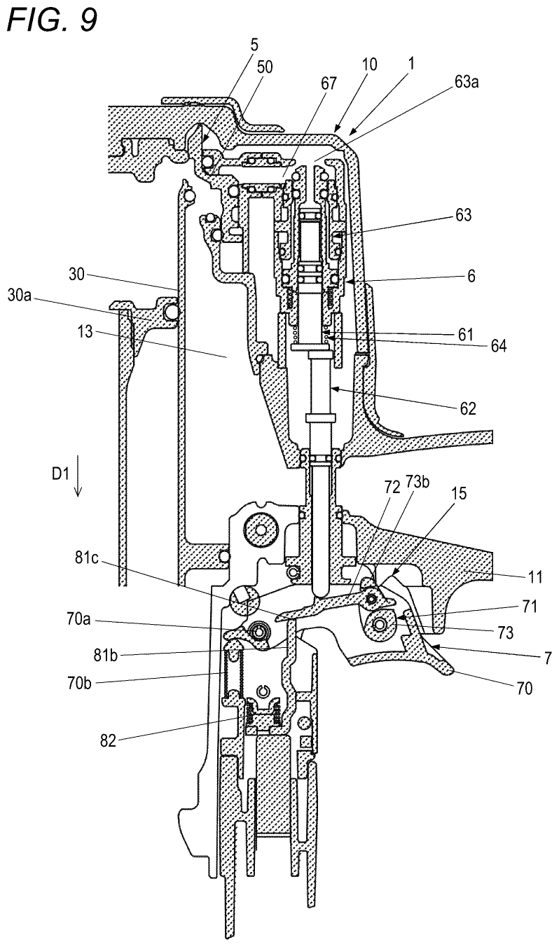

FIG. 9 is a side sectional view of a main part illustrating an example of the operation of the trigger valve portion 6. When the second contact arm 81b moves upward relative to the main body 10, the trigger valve lower stem 62 and the trigger valve upper stem 61 move upward relative to the main body 10. When the trigger valve lower stem 62 and the trigger valve upper stem 61 move to the operation position, the trigger valve portion 6 enters a sign ON state in which the trigger valve portion 6 is operable. When the trigger valve upper stem 61 moves to the operation position and the trigger valve portion 6 enters the sign ON state in which the trigger valve portion 6 is operable, the compressed air is exhausted from the trigger valve lower chamber formed on the lower side of the pilot valve 60 to the exhaust chamber 14, and the pilot valve 60 moves downward. When the pilot valve 60 moves downward, the exhaust portion 63a opens. Accordingly, the compressed air passes through the connection flow path 67 from the control chamber 51 and is exhausted from the exhaust portion 63a to the exhaust chamber 14.

When the compressed air is exhausted from the control chamber 51, the head valve 50 moves upward by the air pressure of the compressed air supplied from the main chamber 13, the compressed air is supplied from the main chamber 13 to the striking cylinder 30, and the striking piston 30a moves downward.

Accordingly, in the state in which the trigger lever 70 is pulled first, when the contact portion 8 moves to a pressing completion position and the trigger valve lower stem 62 moves upward relative to the main body 10 to the operation position, the main valve portion 5 operates and the nail (not illustrated) is driven out.

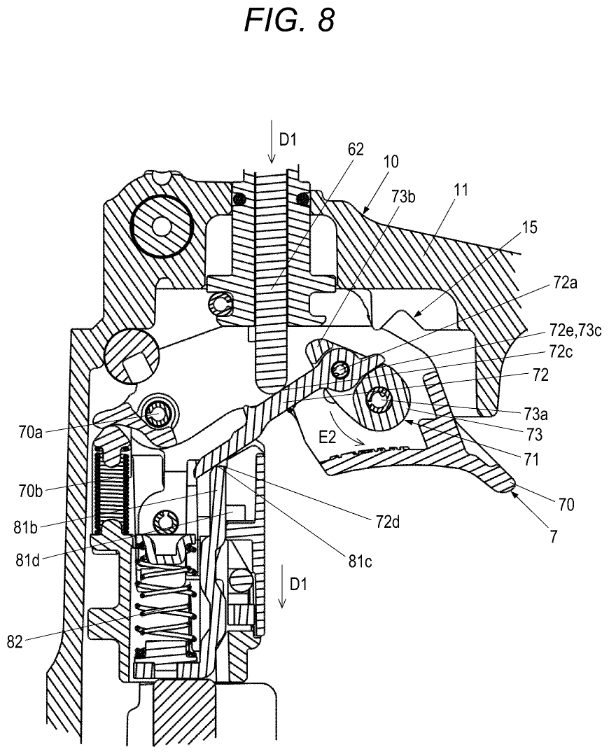

During the continuous driving, when the nail is driven out, the operator moves the nail gun 1 in a direction away from the driven member while pulling the trigger lever 70 to the pulling completion position. When the nail gun 1 moves in the direction away from the driven member, the biasing member 82 extends, so that the second contact arm 81b moves downward as indicated by an arrow D1 relative to the main body 10 from the pressing completion position, as illustrated in FIG. 8.

When the second contact arm 81b moves downward relative to the main body 10 from the pressing completion position, a force of supporting the first lever 72 of the contact lever portion 71 by the second contact arm 81b is released. Further, the trigger valve biasing member 64 illustrated in FIG. 1 extends, and the trigger valve lower stem 62 moves downward as indicated by the arrow D1 relative to the main body 10. Accordingly, the state becomes a sign OFF state. Further, the contact lever portion 71 is biased by the second lever biasing member 75, and the first lever 72 and the second lever 73 rotate in an arrow E2 direction with respect to the trigger lever 70 about the second shaft portion 73a as a fulcrum.

When the first lever 72 and the second lever 73 are biased by the second lever biasing member 75 and rotate in the arrow E2 direction about the second shaft portion 73a as a fulcrum, the trigger valve lower stem 62 is not prevented from moving downward as indicated by the arrow D1 relative to the main body 10, and the sign OFF state is reliably achieved.

When the restricted portion 73b of the second lever 73 is maintained in the state in which the restricted portion 73b is not engaged with the restricting portion 15 while the trigger lever 70 is pulled after the sign OFF state, the contact lever portion 71 rotates in the arrow E2 direction with respect to the trigger lever 70 about the second shaft portion 73a as a fulcrum in the state in which the first lever 72 and the second lever 73 are opened to the maximum. This state is the same as FIG. 6 in which the trigger lever 70 is pulled while the contact portion 8 is at the standby position. Accordingly, the first lever 72 of the contact lever portion 71 moves to the position where the first lever 72 can be engaged with the contact arm 81 that moves downward and then moves upward relative to the main body 10 again.

Therefore, when the operator presses the contact top 80 against the driven member again while pulling the trigger lever 70 and moves the nail gun 1 in the direction toward the driven member as illustrated in FIG. 7, the contact lever portion 71 rotates relative to the trigger lever 70 about the second shaft portion 73a as a fulcrum in a state in which the first lever 72 and the second lever 73 are opened to the maximum, so that the continuous-driving trigger valve stem contact portion 72c of the first lever 72 moves in a direction of pushing the trigger valve lower stem 62. Accordingly, when the trigger valve lower stem 62 moves upward relative to the main body 10, the main valve portion 5 operates and the nail (not illustrated) is driven out.

As described above, the driving operation of nails can be continuously performed by maintaining the state in which the trigger lever 70 is pulled first, pressing the contact top 80 against the driven member, and repeating the operation of moving the nail gun 1 in a direction approaching and away from the driven member.

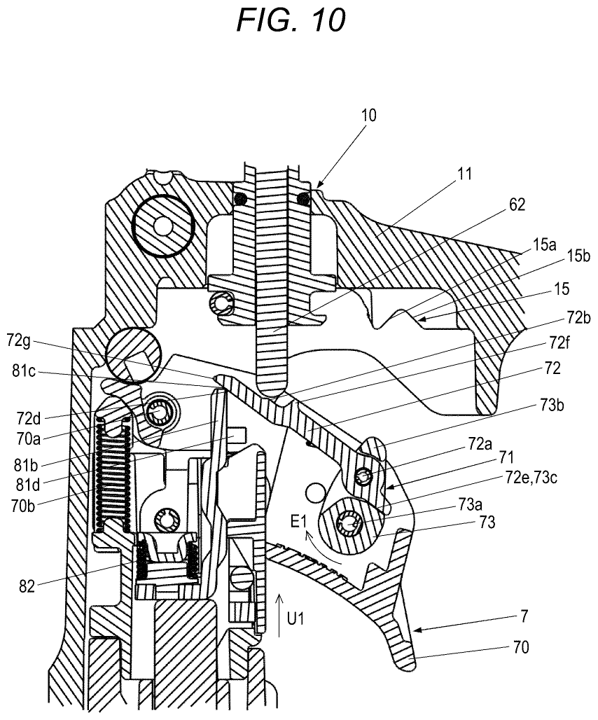

FIGS. 10 to 16 are side sectional views of the main part of the trigger portion illustrating an example of operation of the nail gun according to the present illustrative embodiment during single driving. Next, the operation of the nail gun 1 during the single driving will be described.

At the time of the single driving where a nail is driven by pulling the trigger lever 70 in each driving, the operator first presses the contact top 80 against the driven member from the standby state illustrated in FIG. 5, and moves the nail gun 1 in a direction toward the driven member. When the contact top 80 is pressed against the driven member, as illustrated in FIG. 10, the first contact arm 81a pushes up the second contact arm 81b, and the second contact arm 81b moves upward as indicated by the arrow U1 relative to the main body 10 while compressing the biasing member 82.

When the second contact arm 81b moves upward relative to the main body 10, the arm tip end portion 81c comes into contact with the contact arm contact portion 72d of the first lever 72. When the second contact arm 81b moves to the pressing completion position, the contact lever portion 71 rotates in the arrow E1 direction with respect to the trigger lever 70 about the second shaft portion 73a as a fulcrum in the state in which the first lever 72 and the second lever 73 are opened to the maximum.

The operator presses the contact top 80 against the driven member, moves the nail gun 1 toward the driven member, and pulls the trigger lever 70 in a state in which the second contact arm 81b has moved to the pressing completion position.

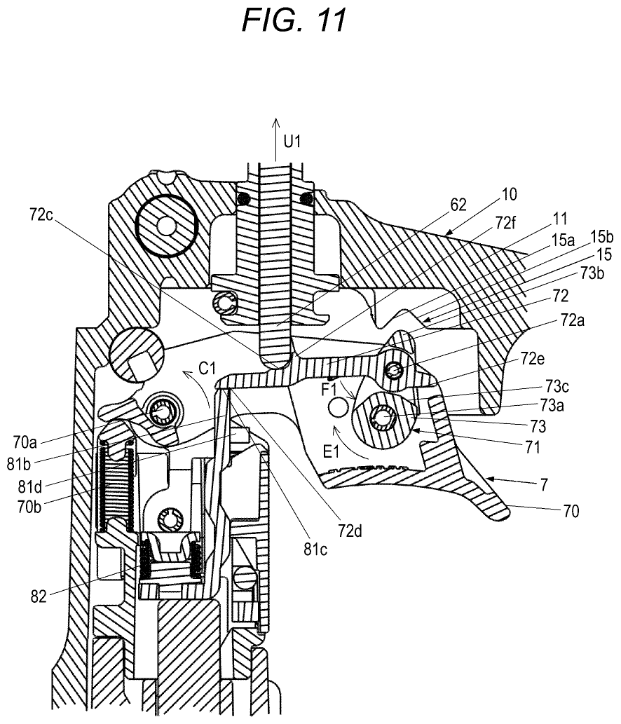

When the trigger lever 70 is pulled, as illustrated in FIG. 11, the trigger lever 70 rotates in the arrow C1 direction about the shaft portion 70a as a fulcrum while compressing the trigger biasing member 70b. When the trigger lever 70 rotates about the shaft portion 70a as a fulcrum, an end portion of the trigger lever 70 on the side extending from the shaft portion 70a along the handle portion 11 moves in a direction approaching the handle portion 11.

When the trigger lever 70 rotates about the shaft portion 70a as a fulcrum, the contact lever portion 71 supported by the trigger lever 70 via the second shaft portion 73a also moves in synchronization. However, since the arm tip end portion 81c of the second contact arm 81b is in contact with the contact arm contact portion 72d, the movement of the contact arm contact portion 72d of the contact lever portion 71 is restricted by the arm tip end portion 81c of the second contact arm 81b.

Thereby, when the trigger lever 70 rotates about the shaft portion 70a as a fulcrum, the single-driving trigger valve stem contact portion 72b of the first lever 72 in the contact lever portion 71 comes into contact with the trigger valve lower stem 62. Further, when the trigger lever 70 rotates about the shaft portion 70a as a fulcrum in a state in which the single-driving trigger valve stem contact portion 72b is in contact with the trigger valve lower stem 62, the first lever 72 moves forward, and the lever restricting portion 72f comes into contact with the trigger valve lower stem 62. When the lever restricting portion 72f comes into contact with the trigger valve lower stem 62, the forward movement of the first lever 72 is restricted. Accordingly, the first lever 72 is maintained in a state in which the single-driving trigger valve stem contact portion 72b is in contact with the trigger valve lower stem 62. Further, when the trigger lever 70 further rotates about the shaft portion 70a as a fulcrum, the forward movement of the first lever 72 is restricted, causing the second lever 73 to rotate in the arrow E1 direction relative to the trigger lever 70 about the second shaft portion 73a as a fulcrum. Further, when the second lever 73 rotates in the arrow E1 direction about the second shaft portion 73a as a fulcrum in a state in which the forward movement of the first lever 72 is restricted, the first shaft portion 72a moves in a direction away from the shaft portion 70a. Further, the first lever 72 rotates in an arrow F1 direction relative to the second lever 73 about the first shaft portion 72a as a fulcrum in a direction in which the contact portion 72e of the first lever 72 and the contacted portion 73c of the second lever 73 are away from each other.

Further, the single-driving trigger valve stem contact portion 72b of the first lever 72 moves in the upper direction of pushing the trigger valve lower stem 62, and moves the trigger valve lower stem 62 upward as indicated by the arrow U1 relative to the main body 10.

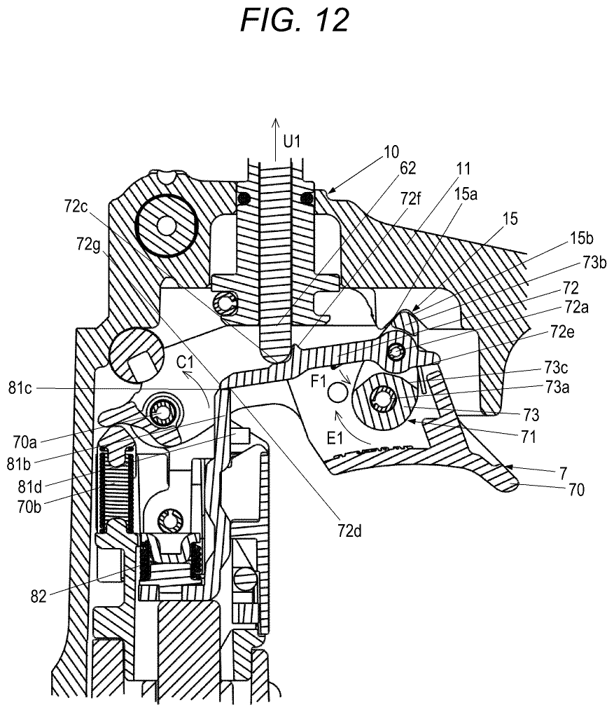

When the operator further pulls the trigger lever 70, as illustrated in FIG. 12, the trigger lever 70 rotates in the arrow C1 direction about the shaft portion 70a as a fulcrum and moves to the pulling completion position, the lever restricting portion 72f comes into contact with the trigger valve lower stem 62, and the forward movement of the first lever 72 is restricted, so that the first lever 72 is maintained in the state in which the single-driving trigger valve stem contact portion 72b comes into contact with the trigger valve lower stem 62. Further, since the forward movement of the first lever 72 is restricted, the second lever 73 of the contact lever portion 71 further rotates in the arrow E1 direction relative to the trigger lever 70 about the second shaft portion 73a as a fulcrum. Further, the first lever 72 further rotates in the arrow F1 direction relative to the second lever 73 about the first shaft portion 72a as a fulcrum in a direction in which the contact portion 72e of the first lever 72 and the contacted portion 73c of the second lever 73 are away from each other, and the first shaft portion 72a moves in a direction away from the shaft portion 70a.

Therefore, the first lever 72 of the contact lever portion 71 further moves in the direction of pushing the trigger valve lower stem 62, and the trigger valve lower stem 62 moves upward as indicated by the arrow U1 relative to the main body 10 to the operation position, so that the trigger valve portion 6 enters the sign ON state in which the trigger valve portion 6 is operable, the main valve portion 5 operates, and the nail (not illustrated) is driven out.

Further, in a state in which the trigger lever 70 rotates about the shaft portion 70a as a fulcrum and the forward movement of the first lever 72 is restricted, when the second lever 73 rotates in the arrow E1 direction about the second shaft portion 73a as a fulcrum and the first lever 72 rotates in the arrow F1 direction about the first shaft portion 72a as a fulcrum, the first shaft portion 72a moves to a position above the second shaft portion 73a. The restricted portion 73b is provided at a position extending from the second shaft portion 73a toward the first shaft portion 72a. Accordingly, the movement trajectory of the restricted portion 73b passes through the portion where the restricting portion 15 is provided, and when the trigger lever 70 moves to the pulling completion position, the restricted portion 73b of the contact lever portion 71 enters the restricting portion 15.

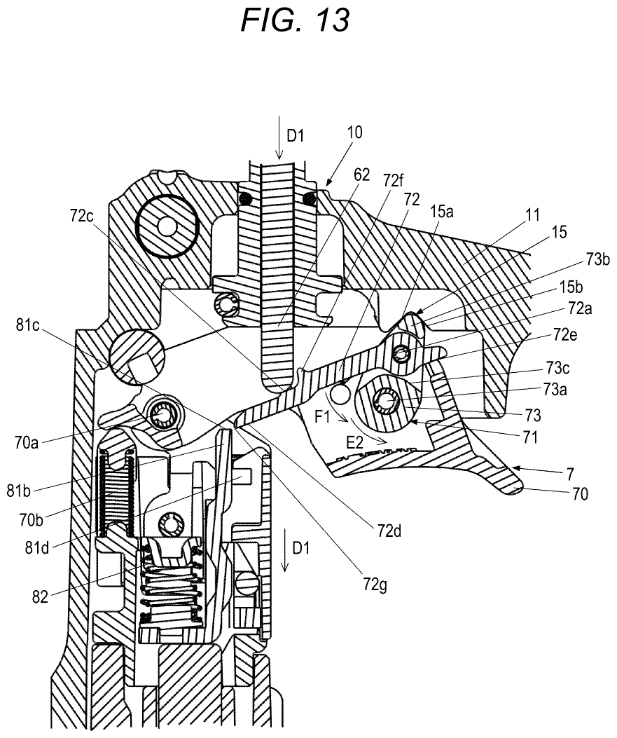

When the nail is driven out, the operator moves the nail gun 1 in the direction away from the driven member, while pulling the trigger lever 70 to the pulling completion position. When the nail gun 1 moves in a direction away from the driven member, the biasing member 82 extends, so that the contact arm 81 moves downward as indicated by the arrow D1 relative to the main body 10 from the pressing completion position, as illustrated in FIG. 13.

Further, when the second contact arm 81b moves downward relative to the main body 10 from the pressing completion position, the support of the first lever 72 of the contact lever portion 71 by the second contact arm 81b is released, the trigger valve biasing member 64 illustrated in FIG. 1 extends, and the trigger valve lower stem 62 moves downward as indicated by the arrow D1 relative to the main body 10. Accordingly, the state becomes the sign OFF state.

Further, when the second contact arm 81b moves downward relative to the main body 10 from the pressing completion position and the trigger valve lower stem 62 moves downward relative to the main body 10, the first lever 72 of the contact lever portion 71 is pushed downward by the trigger valve lower stem 62.

In the contact lever portion 71, the restricted portion 73b of the second lever 73 enters the restricting portion 15, and the front surface of the restricted portion 73b is in contact with the first restricting surface 15a. Accordingly, the rotation of the second lever 73 with respect to the trigger lever 70 is restricted, and when the first lever 72 is pushed downward by the trigger valve lower stem 62, only the first lever 72 is rotatable in the arrow F1 direction about the first shaft portion 72a as a fulcrum.

When the second contact arm 81b moves downward relative to the main body 10, the first lever 72 is pushed downward by the trigger valve lower stem 62, and only the first lever 72 rotates in the arrow F1 direction about the first shaft portion 72a as a fulcrum. When the second contact arm 81b further moves downward relative to the main body 10 and moves to a predetermined engagement release position between the pressing completion position and the standby position, which is the bottom dead center position, the arm tip end portion 81c of the second contact arm 81b moves away from the lever tip end portion 72g of the first lever 72, and only the first lever 72 further rotates in the arrow F1 direction about the first shaft portion 72a as a fulcrum. Further, the lever tip end portion 72g of the first lever 72 moves to a position where the lever tip end portion 72g does not protrude to the movement path of the arm tip end portion 81c of the second contact arm 81b, and the contact arm contact portion 72d deviates from the position where it can be engaged with the contact arm 81.

When the restricted portion 73b of the second lever 73 enters the restricting portion 15 and the front surface of the restricted portion 73b is in contact with the first restricting surface 15a, in the contact lever portion 71, rotation of the second lever 73 in the arrow E2 direction about the second shaft portion 73a as a fulcrum is restricted, and the lever tip end portion 72g of the first lever 72 is restricted from moving in a direction approaching the movement path of the arm tip end portion 81c of the second contact arm 81b. Accordingly, the lever tip end portion 72g of the first lever 72 is restricted from moving to a position where the lever tip end portion 72g protrudes to the movement path of the arm tip end portion 81c of the second contact arm 81b, and is restricted from moving to a position where the lever tip end portion 72g can be engaged with the arm tip end portion 81c of the contact arm 81. Further, since the first lever 72 is restricted from rotating in the direction of pushing up the trigger valve lower stem 62 in the direction opposite to the arrow F1 direction by the trigger valve lower stem 62 biased downward by the trigger valve biasing member 64 via the trigger valve upper stem 61, the lever tip end portion 72g of the first lever 72 is restricted from moving to the position protruding to the movement path of the arm tip end portion 81c of the second contact arm 81b, and is restricted from moving to the position where it can be engaged with the arm tip end portion 81c of the contact arm 81.

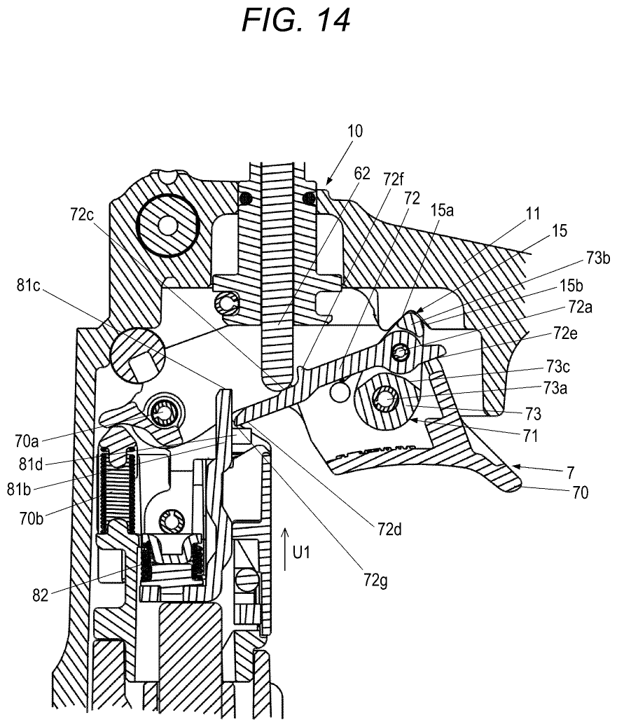

Therefore, even when the second contact arm 81b is moved upward as indicated by the arrow U1 relative to the main body 10 as illustrated in FIG. 14 in a state in which the operator pulls the trigger lever 70 from a state in which the second contact arm 81b has moved to a position between a position lower than the predetermined engagement release position and the bottom dead center position, the movement of the lever tip end portion 72g of the first lever 72 to the position where the lever tip end portion 72g protrudes to the movement path of the arm tip end portion 81c of the second contact arm 81b is restricted, and the first lever 72 of the contact lever portion 71 is not engaged with the arm tip end portion 81c of the second contact arm 81b.

Accordingly, the first lever 72 of the contact lever portion 71 does not move in the direction of pushing the trigger valve lower stem 62, and the trigger valve lower stem 62 does not move upward relative to the main body 10. Therefore, the sign OFF state is maintained.

Then, when the nail gun 1 is moved in the direction away from the driven member again in the state in which the trigger lever 70 is pulled, as illustrated in FIG. 14, the contact arm 81 moves downward as indicated by the arrow D1 relative to the main body 10.

Since the restricted portion 73b of the second lever 73 is in the state of being engaged with the restricting portion 15, even when the contact arm 81 moves to the standby position, the state in which the movement of the first lever 72 of the contact lever portion 71 to the position where the first lever 72 can be engaged with the contact arm 81 is restricted is maintained.

Therefore, after the nail is driven out by first pressing the contact top 80 against the driven member, moving the nail gun 1 in the direction approaching the driven member, and then pulling the trigger lever 70, even if the operation of pressing the contact top 80 against the driven member and moving the nail gun 1 in the direction approaching and the direction away from the driven member is repeated while maintaining the state in which the trigger lever 70 is pulled, the sign OFF state is maintained, and the nails are not continuously driven out.

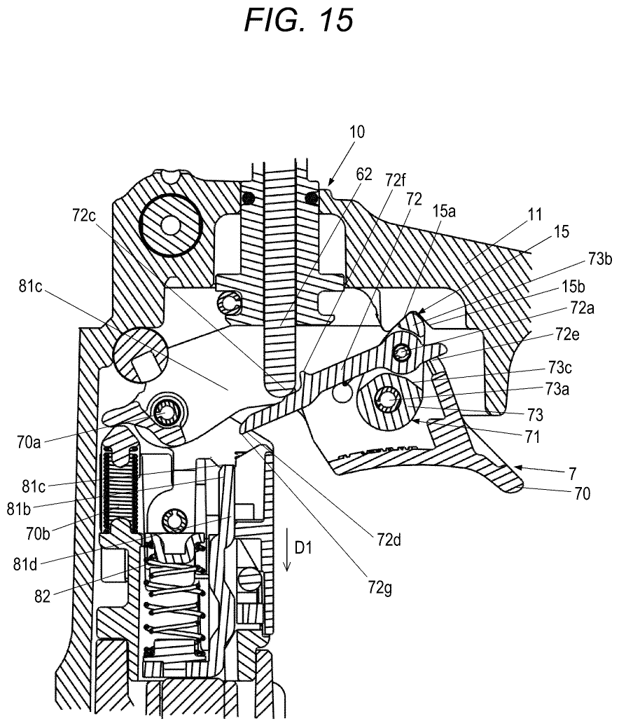

On the other hand, for example, the operator loosens a force of pulling the trigger lever 70 or releases the trigger lever 70 from the state illustrated in FIG. 13. Accordingly, as illustrated in FIG. 15, as the trigger biasing member 70b extends, the trigger lever 70 rotates in the arrow C2 direction about the shaft portion 70a as a fulcrum and moves in a direction away from the handle portion 11. When the trigger lever 70 moves in the direction away from the handle portion 11, the engagement between the restricted portion 73b of the second lever 73 and the restricting portion 15 is released, and the trigger lever 70 returns to the standby state of FIG. 9, so that the first lever 72 of the contact lever portion 71 can move to the position where the first lever 72 is engaged with the second contact arm 81b.

Thereafter, when continuously driving the nails, the trigger lever 70 is pulled first, and then the nail gun 1 may repeatedly move in the direction approaching and the direction away from the driven member.

On the other hand, when the trigger lever 70 is pulled after the contact top 80 is pressed against the driven member and the nail gun 1 is moved in the direction approaching the driven member, the nail gun 1 is raised by a reaction after the nail is driven out, the contact portion 8 moves relatively downward, the arm tip end portion 81c of the second contact arm 81b moves away from the lever tip end portion 72g of the first lever 72, and the engagement between the first lever 72 and the second contact arm 81b is released. In this case, the force of pulling the trigger lever 70 is loosened or the trigger lever 70 is released, the contact portion 8 is pressed against the driven member again, and then the trigger lever 70 is pulled, thereby making it possible to drive out the nail. Accordingly, the single driving of the nail is possible.

By strengthening the pressing of the nail gun against the driven member, it is possible to prevent the nail gun 1 from moving in a direction away from the driven member due to reaction when the nail is driven out, and to prevent the second contact arm 81b from moving to a position between a position below the predetermined engagement release position and the bottom dead center position. In this state, the force of pulling the trigger lever 70 is loosened, or the trigger lever 70 is released, and then the nail gun 1 is moved in the lateral direction without separating the contact top 80 from the driven member, and at the next driving position, the nail gun 1 is moved in a direction in which the nail gun 1 approaches the driven member, and the trigger lever 70 is pulled, thereby driving out a nail. This is also referred to as a sliding driving operation.

When such an operation is performed, as illustrated in FIG. 14, in a state in which the second contact arm 81b is positioned between the top dead center position and the engagement release position, the movement of the first lever 72 in the direction along the second contact arm 81b is restricted by the second restricting portion 81d, so that the first lever 72 is restricted from being pushed by the trigger valve lower stem 62 and moving further downward. Accordingly, in the operation in which the trigger lever 70 rotates in the arrow C2 direction about the shaft portion 70a as a fulcrum by loosening the force of pulling the trigger lever 70 or releasing the trigger lever 70, the lever tip end portion 72g of the first lever 72 is prevented from being caught by the second contact arm 81b, or the lever tip end portion 72g of the first lever 72 is prevented from erroneously entering a gap between the second contact arm 81b and a housing forming the main body 10, and the contact lever portion 71 can return to the initial position. Therefore, the first lever 72 is prevented from being unable to return to the initial position due to the above-described sliding driving operation, and the sliding driving can be stably performed.

The restricting portion 15 is provided on the handle portion 11 as, for example, a substantially V-shaped groove. The restricting portion 15 is provided on the handle portion 11 integrated with the body portion 10a, that is, provided on the main body 10, so that a contact area that can come into contact with the restricted portion 73b can be ensured. Further, the restricted portion 73b can protrude from the second shaft portion 73a toward the first shaft portion 72a to further increase the contact area. Further, it is also possible to further increase the contact area by causing the first restricting surface 15a of the restricting portion 15 to protrude downward and to come into contact with a portion of the restricted portion 73b below the second lever 73. Accordingly, the contact area is increased compared to the case where the trigger valve lower stem 62 is provided with an engaging portion with the contact lever portion 71, so that the restriction of the contact lever portion 71 is stabilized. Therefore, it is not necessary to process the trigger valve lower stem 62 and the contact lever portion 71 with high accuracy, and high accuracy is not required for a dimension setting and high processing accuracy is also not required in order to enable the restricting portion 15 and the restricted portion 73b of the second lever 73 to be engaged with each other. Further, since it is not necessary to form a stress concentration portion such as a groove in the trigger valve lower stem 62, strength can be ensured. Therefore, the position of the contact lever portion 71 can be reliably restricted.

### Modification of Nail Gun

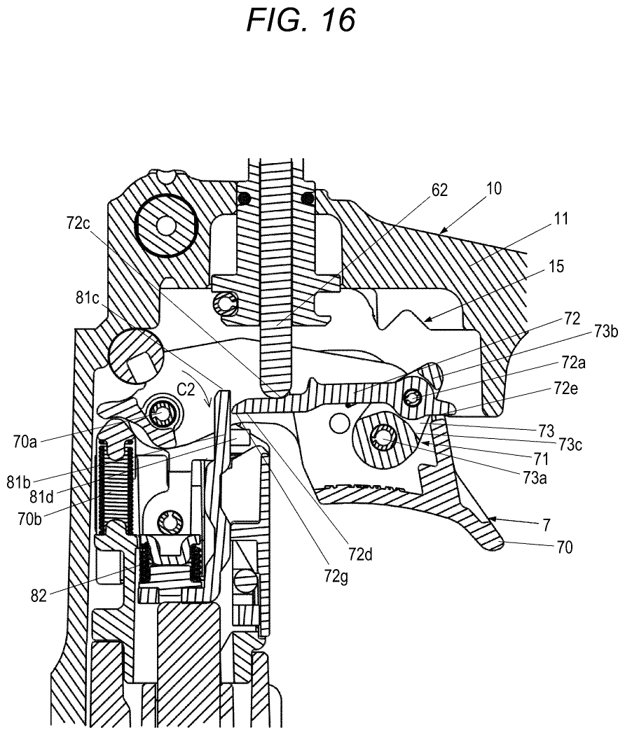

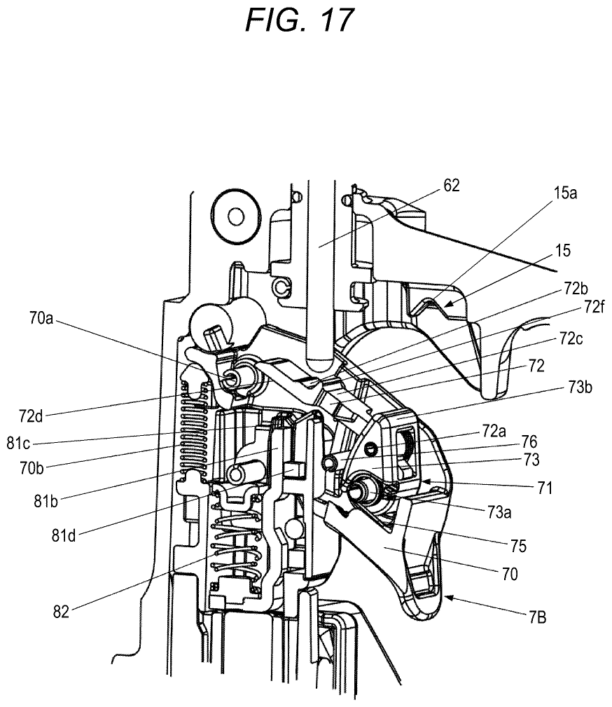

FIG. 16 is a perspective view of a main part illustrating a modification of the nail gun according to the present illustrative embodiment, and FIG. 17 is a side sectional view of a main part of a trigger portion illustrating the modification of the nail gun according to the present illustrative embodiment. The nail gun according to the modification of the present illustrative embodiment includes a continuous-driving restricting portion 76 that restricts the movement of the contact lever portion 71 at a position where the restricted portion 73b of the second lever 73 can be engaged with the restricting portion 15. The continuous-driving restricting portion 76 is an example of a third restricting portion, and is provided on the movement path of the second lever 73 rotating about the second shaft portion 73a as a fulcrum in the contact lever portion 71. For example, as illustrated in FIG. 3, the continuous-driving restricting portion 76 is implemented by inserting a cylindrical or columnar pin into a hole portion 76a opened in the trigger lever 70. The continuous-driving restricting portion 76 restricts rotation of the second lever 73 about the second shaft portion 73a as a fulcrum. That is, the continuous-driving restricting portion 76 restricts the movement of the lever tip end portion 72g in the direction approaching the movement path of the arm tip end portion 81c of the second contact arm 81b. When the trigger lever 70 rotates about the shaft portion 70a as a fulcrum, the continuous-driving restricting portion 76 restricts the single-driving trigger valve stem contact portion 72b from rotating about the second shaft portion 73a of the second lever 73 as a fulcrum at a position in contact with the trigger valve lower stem 62. Thus, the third restricting portion 76 is one example of a third position limiting surface that restricts a position of the contact lever portion 71.

When the trigger lever 70 is pulled and rotates about the shaft portion 70a as a fulcrum in a state in which the rotation of the second lever 73 is restricted by the continuous-driving restricting portion 76, in the contact lever portion 71, the single-driving trigger valve stem contact portion 72b of the first lever 72 comes into contact with the trigger valve lower stem 62. Further, when the trigger lever 70 rotates about the shaft portion 70a as a fulcrum in a state in which the single-driving trigger valve stem contact portion 72b is in contact with the trigger valve lower stem 62, the first lever 72 moves forward, and the lever restricting portion 72f comes into contact with the trigger valve lower stem 62. When the lever restricting portion 72f comes into contact with the trigger valve lower stem 62, the forward movement of the first lever 72 is restricted. Accordingly, the first lever 72 is maintained in a state in which the single-driving trigger valve stem contact portion 72b is in contact with the trigger valve lower stem 62. Further, when the trigger lever 70 further rotates about the shaft portion 70a as a fulcrum, the forward movement of the first lever 72 is restricted, causing the second lever 73 to rotate in the arrow E1 direction relative to the trigger lever 70 about the second shaft portion 73a as a fulcrum. Further, when the second lever 73 rotates in the arrow E1 direction about the second shaft portion 73a as a fulcrum in a state in which the forward movement of the first lever 72 is restricted, the first shaft portion 72a moves in a direction away from the shaft portion 70a. Further, the first lever 72 rotates in the arrow F1 direction relative to the second lever 73 about the first shaft portion 72a as a fulcrum in the direction in which the contact portion 72e of the first lever 72 and the contacted portion 73c of the second lever 73 are away from each other. Further, in a state in which the trigger lever 70 rotates about the shaft portion 70a as a fulcrum and the forward movement of the first lever 72 is restricted, when the second lever 73 rotates in the arrow E1 direction about the second shaft portion 73a as a fulcrum and the first lever 72 rotates in the arrow F1 direction about the first shaft portion 72a as a fulcrum, the first shaft portion 72a moves to a position above the second shaft portion 73a. The restricted portion 73b is provided at a position extending from the second shaft portion 73a toward the first shaft portion 72a. Accordingly, the movement trajectory of the restricted portion 73b passes through the portion where the restricting portion 15 is provided. Therefore, when the trigger lever 70 is pulled to the pulling completion position in a state in which the rotation of the second lever 73 is restricted by the continuous-driving restricting portion 76, the restricted portion 73b of the second lever 73 enters the restricting portion 15, and the movement of the contact lever portion 71 is restricted. Accordingly, the continuous-driving restricting portion 76 restricts the first lever 72 of the contact lever portion 71 from moving to a position where the first lever 72 can be engaged with the contact arm 81, and enables only the single driving. Other configurations are the same as those of the nail gun 1 described above.

Note that, by making the continuous-driving restricting portion 76 attachable to and detachable from the trigger lever 70, it is possible to switch between a nail gun that can perform the above-described continuous driving and single driving and a nail gun that enables only the single driving.

### Operation Example of Nail Gun of Modification

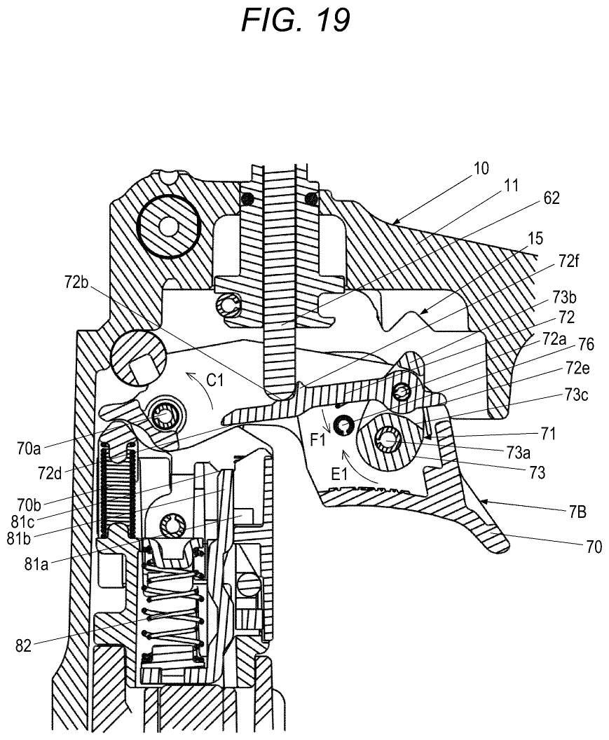

FIGS. 19 to 21 are side sectional views of a main part of a trigger portion illustrating an example of operation of restricting continuous driving of the nail gun according to the modification.

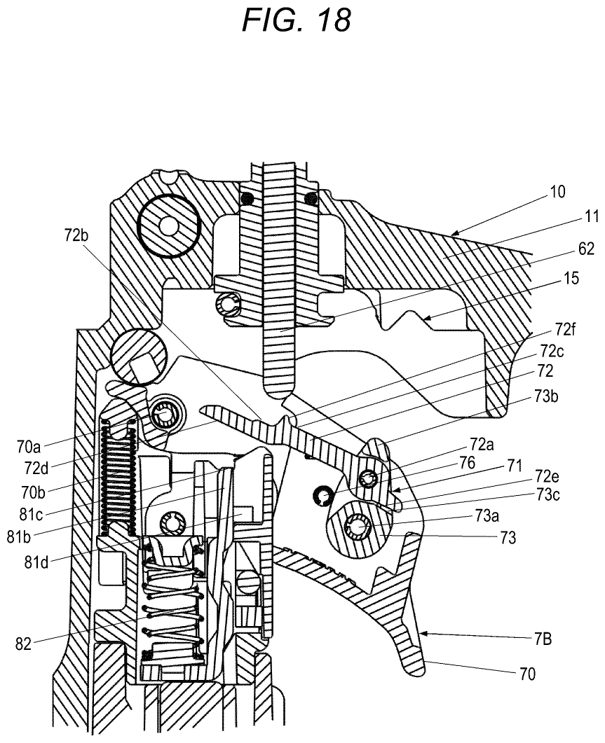

It is assumed that the operator pulls the trigger lever 70 before pressing the contact top 80 against the driven member. In the standby state illustrated in FIG. 18, since the continuous-driving restricting portion 76 is in contact with the second lever 73, the orientation of the contact lever portion 71 rotating about the second shaft portion 73a as a fulcrum is restricted to a position similar to that in the state in which the contact arm 81 moves upward relative to the main body 10 and pushes up the first lever 72. When the trigger lever 70 is pulled from the standby state illustrated in FIG. 18, as illustrated in FIG. 19, the trigger lever 70 rotates in the arrow C1 direction about the shaft portion 70a as a fulcrum while compressing the trigger biasing member 70b. When the trigger lever 70 rotates about the shaft portion 70a as a fulcrum, an end portion of the trigger lever 70 on the side extending from the body portion 10a along the handle portion 11 moves in a direction approaching the handle portion 11.

When the trigger lever 70 rotates about the shaft portion 70a as a fulcrum, the contact lever portion 71 supported by the trigger lever 70 via the second shaft portion 73a also moves in synchronization.

As described above, when the trigger lever 70 is pulled and rotates about the shaft portion 70a as a fulcrum in a state in which the rotation of the second lever 73 is restricted by the continuous-driving restricting portion 76, in the contact lever portion 71, the single-driving trigger valve stem contact portion 72b of the first lever 72 comes into contact with the trigger valve lower stem 62. Further, when the trigger lever 70 rotates about the shaft portion 70a as a fulcrum in a state in which the single-driving trigger valve stem contact portion 72b is in contact with the trigger valve lower stem 62, the first lever 72 moves forward, and the lever restricting portion 72f comes into contact with the trigger valve lower stem 62. When the lever restricting portion 72f comes into contact with the trigger valve lower stem 62, the forward movement of the first lever 72 is restricted. Accordingly, the first lever 72 is maintained in a state in which the single-driving trigger valve stem contact portion 72b is in contact with the trigger valve lower stem 62. The first lever 72 is restricted from rotating in the direction of pushing up the trigger valve lower stem 62 by the trigger valve lower stem 62 biased downward by the trigger valve biasing member 64 via the trigger valve upper stem 61. Accordingly, when the trigger lever 70 further rotates about the shaft portion 70a as a fulcrum, the forward movement of the first lever 72 is restricted, causing the second lever 73 to rotate in the arrow E1 direction relative to the trigger lever 70 about the second shaft portion 73a as a fulcrum. Further, when the second lever 73 rotates in the arrow E1 direction about the second shaft portion 73a as a fulcrum in a state in which the forward movement of the first lever 72 is restricted, the first shaft portion 72a moves in a direction away from the shaft portion 70a. Further, the first lever 72 rotates in the arrow F1 direction relative to the second lever 73 about the first shaft portion 72a as a fulcrum in the direction in which the contact portion 72e of the first lever 72 and the contacted portion 73c of the second lever 73 are away from each other. Further, in a state in which the trigger lever 70 rotates about the shaft portion 70a as a fulcrum and the forward movement of the first lever 72 is restricted, when the second lever 73 rotates in the arrow E1 direction about the second shaft portion 73a as a fulcrum and the first lever 72 rotates in the arrow F1 direction about the first shaft portion 72a as a fulcrum, the first shaft portion 72a moves to a position above the second shaft portion 73a. The restricted portion 73b is provided at a position extending from the second shaft portion 73a toward the first shaft portion 72a. Accordingly, the movement trajectory of the restricted portion 73b passes through the portion where the restricting portion 15 is provided.

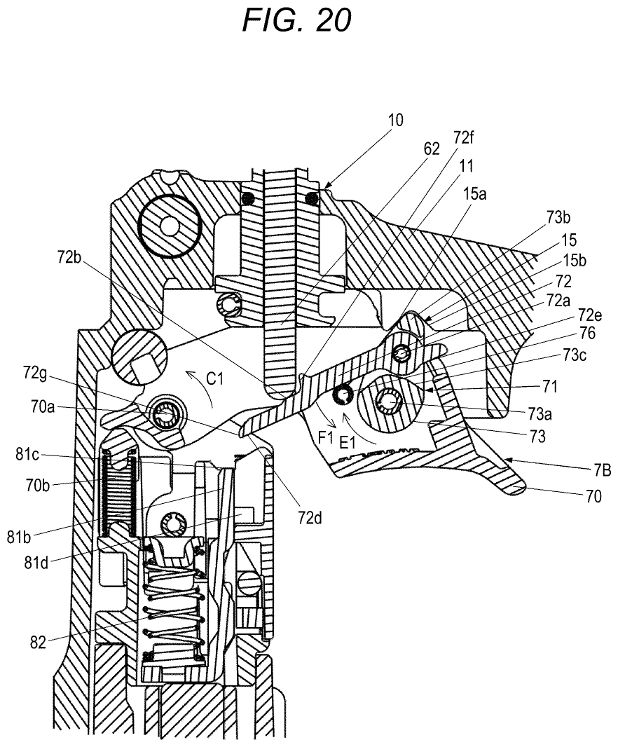

When the operator further pulls the trigger lever 70, as illustrated in FIG. 20, the trigger lever 70 rotates in the arrow C1 direction about the shaft portion 70a as a fulcrum and moves to the pulling completion position, the second lever 73 of the contact lever portion 71 further rotates in the arrow E1 direction with respect to the trigger lever 70 about the second shaft portion 73a as a fulcrum. Further, the first lever 72 further rotates in the arrow F1 direction relative to the second lever 73 about the first shaft portion 72a as a fulcrum in a direction in which the contact portion 72e of the first lever 72 and the contacted portion 73c of the second lever 73 are away from each other.

Thus, the first lever 72 of the contact lever portion 71 does not move in the direction of pushing the trigger valve lower stem 62, and the trigger valve lower stem 62 does not move upward relative to the main body 10. Therefore, the main valve portion 5 does not operate, and driving operation of the nail (not illustrated) is not performed.

Further, when the trigger lever 70 moves to the pulling completion position, the restricted portion 73b of the contact lever portion 71 is engaged with the restricting portion 15. In the contact lever portion 71, when the trigger lever 70 moves to the pulling completion position and the restricted portion 73b is engaged with the restricting portion 15, the lever tip end portion 72g of the first lever 72 is restricted from moving in a direction approaching the movement path of the arm tip end portion 81c of the second contact arm 81b. Accordingly, the lever tip end portion 72g of the first lever 72 is restricted from moving to a position where the lever tip end portion 72g protrudes to the movement path of the arm tip end portion 81c of the second contact arm 81b, and is restricted from moving to a position where the lever tip end portion 72g can be engaged with the arm tip end portion 81c of the contact arm 81. Therefore, the contact arm contact portion 72d of the first lever 72 deviates from the position where it can be engaged with the contact arm 81.

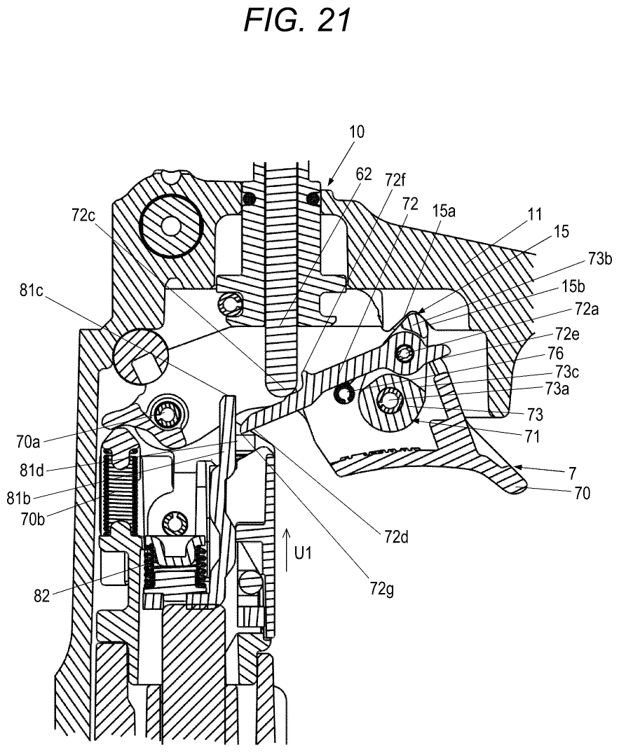

Accordingly, even when the contact top 80 is pressed against the driven member in a state in which the operator pulls the trigger lever 70 and the contact arm 81 moves upward as indicated by the arrow U1 relative to the main body 10 as illustrated in FIG. 21, the first lever 72 of the contact lever portion 71 is not engaged with the contact arm 81.

Thus, the first lever 72 of the contact lever portion 71 does not move in the direction of pushing the trigger valve lower stem 62, and the trigger valve lower stem 62 does not move upward relative to the main body 10. Since the trigger valve lower stem 62 does not move upward relative to the main body 10, the main valve portion 5 does not operate, and the driving operation of the nail (not illustrated) is not performed. Accordingly, the continuous driving is restricted by pulling the trigger lever 70 first and then repeating the operation of moving the nail gun in the direction approaching and away from the driven member.

On the other hand, even in the configuration in which the trigger lever 70 is provided with the continuous-driving restricting portion 76, the contact arm contact portion 72d can be engaged since the contact arm contact portion 72d protrudes to the movement path of the second contact arm 81b during standby, and similarly to the operation of FIGS. 10 to 16 described above, the nail is driven out by first pressing the contact top 80 against the driven member, moving the nail gun 1 in the direction toward the driven member, and then pulling the trigger lever 70. After the nail is driven out, by loosening the force of pulling the trigger lever 70, or releasing the trigger lever 70, and then pulling the trigger lever 70 again, it possible to drive out the nail. Accordingly, only the single driving of the nail is enabled.

What is claimed is:

1. A driving tool comprising:
a main body;
a main chamber configured to store compressed air;
a striking cylinder configured to move a striking piston in an axial direction by being supplied with the compressed air stored in the main chamber;
a main valve portion configured to open and close communication between the striking cylinder and the main chamber;
a trigger valve portion configured to cause the main valve portion to operate;
a trigger portion configured to cause the trigger valve portion to operate; and
a contact portion supported to be movable in a driving direction of the striking piston and configured to cause the trigger valve portion to operate in cooperation with an operation of the trigger portion,
wherein the main body includes:
a body portion extending in an up-down direction; and
a handle portion extending from the body portion in a direction intersecting the body portion,
wherein the contact portion includes:
a contact top configured to be pressed against a driven member; and
a contact arm connected to the contact top and having an arm tip end portion engageable with the trigger portion,
wherein the trigger valve portion includes:
a pilot valve causing the main valve portion to operate; and
a trigger valve stem controlling intake and exhaust of compressed air to switch presence and absence of operation of the pilot valve,
wherein the trigger portion includes:
a trigger lever movably supported with respect to the main body;
a contact lever portion movably supported by the trigger lever and engageable with the contact arm and the trigger valve stem of the trigger valve portion; and
a resilient member configured to bias the contact lever portion to a position where the contact lever portion is engaged with the contact arm by protruding the contact lever portion to a movement path of the arm tip end portion of the contact arm, and
wherein the main body includes a position limiting surface that is contactable by a restricted portion of the contact lever portion and limits movement of the contact lever portion to the position where the contact lever portion is engaged with the contact arm.

2. The driving tool according to claim 1, wherein the position limiting surface limits the contact lever portion from protruding to the movement path of the arm tip end portion of the contact arm when the contact lever portion comes into contact with the position limiting surface.

3. The driving tool according to claim 2, wherein in a case where the contact arm moves upward before the trigger lever moves, the contact arm is engaged with the contact lever portion, and when the trigger lever moves after the contact arm moved upward, the contact lever portion moves the trigger valve stem, the trigger valve portion operates, and the contact lever portion comes into contact with the position limiting surface.

4. The driving tool according to claim 1, wherein the contact lever portion includes the restricted portion, and the restricted portion is configured to restrict the contact lever portion from protruding to a movement path of the arm tip end portion of the contact arm when the contact lever portion comes into contact with the position limiting surface.

5. The driving tool according to claim 1, wherein the contact lever portion includes:
a first lever engageable with the arm tip end portion of the contact arm, and
a second lever movably supported by the trigger lever, the first lever being movably supported relative to the second lever.

6. The driving tool according to claim 5, wherein the second lever includes the restricted portion, and the restricted portion comes into contact with the position limiting surface when the trigger lever moves.

7. The driving tool according to claim 5,
wherein the second lever includes:
a first shaft portion that rotatably supports the first lever; and
the restricted portion, the restricted portion coming into contact with the position limiting surface by movement of the trigger lever, and
wherein the second lever is rotatably supported by the trigger lever with a second shaft portion as a fulcrum, and when the restricted portion comes into contact with the position limiting surface, rotation of the second lever is restricted.

8. The driving tool according to claim 7,
wherein the first lever includes a contact portion configured to be in contact with the second lever,
wherein the second lever includes a contacted portion configured to be in contact with the contact portion, and
wherein the resilient member biases the first lever and the second lever in a direction in which the contact portion and the contacted portion come into contact with each other.

9. The driving tool according to claim 8, wherein in the contact lever portion, the first lever and the second lever rotate about the second shaft portion as a fulcrum with respect to the trigger lever in a state in which the contact portion and the contacted portion are in contact with each other.

10. The driving tool according to claim 7,
wherein the first lever includes a lever restricting portion configured to be in contact with the trigger valve stem, and
wherein in the contact lever portion, when the lever restricting portion comes into contact with the trigger valve stem, the movement of the first lever is restricted, and the restricted portion is guided to the position limiting surface by the movement of the trigger lever.

11. The driving tool according to claim 7, wherein in the contact lever portion, the first lever rotates about the first shaft portion as a fulcrum with respect to the second lever in a state in which the restricted portion is in contact with the position limiting surface and the rotation of the second lever is restricted.

12. The driving tool according to claim 5, further comprising:
a second position limiting surface configured to restrict a downward movement of the first lever along the contact arm, the first lever being restricted from moving to a position where the first lever is engaged with the contact arm.

13. The driving tool according to claim 12, wherein the second position limiting surface is provided on the contact arm.

14. The driving tool according to claim 4, wherein the trigger portion includes a third position limiting surface configured to restrict movement of the contact lever portion at a position where the restricted portion is engageable with the position limiting surface and a position where the contact lever portion is engageable with the contact arm.

15. The driving tool according to claim 14, wherein the third position limiting surface is provided on a member that is attachable to and detachable from the trigger lever.
